(19) United States
(12) Patent Application Publication
(10) Pub. No.: US 2014/0317911 A1
(43) Pub. Date: Oct. 30, 2014

(54) METHOD OF MANUFACTURING DISK DRIVE UNIT

(71) Applicant: Samsung Electro-Mechanics Japan Advanced Technology Co., Ltd., Shizuoka (JP)

(72) Inventor: Hisayuki AOSHIMA, Shizuoka (JP)

(73) Assignee: Samsung Electro-Mechanics Japan Advanced Technology Co., Ltd., Shizuoka (JP)

(21) Appl. No.: 14/251,711

(22) Filed: Apr. 14, 2014

(30) Foreign Application Priority Data
Apr. 25, 2013 (JP) 2013-092844

(51) Int. Cl. G11B 25/04

(52) U.S. Cl. CPC G11B 25/043
USPC 29/603.03

(57) ABSTRACT

A method manufactures a disk drive unit that includes a rotor to rotate a disk set thereon, and a fixed body to rotatably support the rotor via a lubricant, by cutting the rotor integrally including a sleeve surrounding a shaft of the fixed body and a hub on which the disk is set, by a wavy cutting process to form a dynamic pressure generating groove to generate a dynamic pressure in the lubricant and having wavy undulations at a bottom part thereof, and cutting a surface of the rotor opposing a ring-shaped member that is included in the fixed body and covers a gas-liquid interface of the lubricant provided between the rotor and the fixed body, by a wavy cutting process to form an air flow generating groove to generate an air flow between the rotor and the ring-shaped member and having wavy undulations at a bottom part thereof.

### CROSS-REFERENCE TO RELATED APPLICATIONS

This application is based upon and claims the benefit of priority of Japanese Patent Application No. 2013-092844 filed on Apr. 25, 2013, the entire contents of which are incorporated herein by reference.

### BACKGROUND OF THE INVENTION

1. Field of the Invention

The present invention relates to a method of manufacturing a disk drive unit.

2. Description of the Related Art

In a disk drive unit, such as a HDD (Hard Disk Drive), for example, the rotational speed is improved considerably by using a fluid dynamic bearing, and the size is reduced. In addition, the storage capacity of the HDD is increased, and the HDD is used in various electronic apparatuses. There are demands to reduce the thickness and weight of the HDD and to improve rigidity in order to withstand vibrations when carried, so that the HDD may be used in portable electronic apparatuses such as a lap-top computer, portable music player, and the like.

The fluid dynamic bearing of the disk drive unit, such as the HDD, may have a configuration in which a sleeve that surrounds a fixed shaft and a hub mounted with a disk rotate about a center of the fixed shaft, for example.

Generally, in the above configuration of the fluid dynamic bearing, a lubricant is provided between the fixed shaft and the sleeve, and a dynamic pressure generating groove for generating a dynamic pressure in the lubricant is provided in an inner peripheral surface or the like of the sleeve. Such a dynamic pressure generating groove may be formed by pressing a groove forming tool having a plurality of rolling balls embedded at a tip end thereof, for example, against the inner peripheral surface of the sleeve along a desired groove shape. Such a process is proposed in Japanese Laid-Open Patent Publications No. 10-76411 and No. 11-19804, for example.

However, according to the process using the rolling balls, a large stress is applied on the sleeve when the tool is pressed against the sleeve, and the sleeve may easily become deformed and deteriorate the dimension accuracy of the sleeve after the process. In addition, according to the process using the rolling balls, it is difficult to form extremely small grooves, such as the dynamic pressure generating groove, in a hard material. For example, when the sleeve and the hub are integrally formed by a relatively hard stainless steel or the like in order to improve the dimension accuracy, for example, it may be difficult to form the dynamic pressure generating groove in the sleeve with a high accuracy.

The dynamic pressure generating groove may be formed in the sleeve by coining, ECM (Electro-Chemical Machining), or the like, however, it may be difficult to form the dynamic pressure generating groove with a high accuracy using such methods depending on the material of the sleeve, similarly as in the case of the process using the rolling balls. In addition, the ECM requires a large number of processes, and the cost may become high due to the process using electrolyte solution and the like.

In order to reduce the size and thickness of the disk drive unit and also improve the rigidity of the disk drive unit at the same time, it is essential to improve the dimension accuracy of the sleeve and the hub and to improve the accuracy of the process to form the extremely small dynamic pressure generating groove. However, according to the methods described above, it may be difficult to form the dynamic pressure generating groove with a high accuracy, because the dynamic pressure generating groove is becoming extremely small due to the reduction in the size and thickness of the disk drive unit.

### SUMMARY OF THE INVENTION

Embodiments of the present invention may provide a method of manufacturing a disk drive unit that can form a dynamic pressure generating groove of a fluid dynamic bearing with a high accuracy and improve rigidity of the disk drive unit.

According to one aspect of the present invention, a method of manufacturing a disk drive unit that includes a rotor configured to rotate a disk set thereon, and a fixed body configured to rotatably support the rotor via a lubricant, includes first cutting the rotor which integrally includes a sleeve part surrounding a shaft part of the fixed body and a hub part on which the disk is set, by a wavy cutting process to form a dynamic pressure generating groove configured to generate a dynamic pressure in the lubricant and having wavy undulations at a bottom part thereof; second cutting a surface of the rotor opposing a ring-shaped member that is included in the fixed body and covers a gas-liquid interface of the lubricant provided between the rotor and the fixed body, by a wavy cutting process to form a first air flow generating groove configured to generate an air flow between the rotor and the ring-shaped member and having wavy undulations at a bottom part thereof; and third cutting a surface of the hub part opposing the fixed body, by a wavy cutting process to form a second air flow generating groove configured to generate an air flow between the rotor and the fixed body and having wavy undulations at a bottom part thereof.

Other objects and further features of the present invention may be apparent from the following detailed description when read in conjunction with the accompanying drawings.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A, 1B, and 1C are diagrams for explaining an example of a configuration of a disk drive unit in one embodiment;

FIG. 2 is a cross sectional view illustrating the configuration of one part of the disk drive unit in one embodiment;

FIG. 3 is a diagram illustrating an example of a general configuration of a cutting apparatus to cut a dynamic pressure generating groove;

FIG. 4 is a diagram illustrating the example of the general configuration of the cutting apparatus to cut the dynamic pressure generating groove;

FIG. 5 is a diagram schematically illustrating a state in which a tool bit of the cutting apparatus forms a groove in a hub;

FIG. 6 is a diagram schematically illustrating a state in which a thrust dynamic generating groove is formed;

FIG. 7 is a diagram illustrating an example of a cross section along a line B-B in FIG. 6;

FIGS. 8A, 8B, and 8C are diagrams illustrating an example of a process to cut the hub in one embodiment;

FIGS. 9A, 9B, and 9C are diagrams illustrating the example of the process to cut the hub in one embodiment;

FIG. 10 is a diagram illustrating an example of the thrust dynamic pressure generating groove and an air flow generating groove formed in a bottom surface of the hub by the cutting process;

FIG. 11 is a diagram illustrating an example of the thrust dynamic pressure generating groove and the air flow generating groove formed in an upper surface of the hub by the cutting process; and

FIG. 12 is a diagram illustrating an example of radial dynamic pressure generating grooves formed in an inner peripheral surface of a sleeve.

### DESCRIPTION OF THE PREFERRED EMBODIMENTS

In each of the figures described hereunder, those elements and parts that are the same or substantially the same are designated by the same reference numerals, and a description thereof will not be repeated where appropriate. In addition, dimensions of the parts in each of the figures are enlarged or reduced, where appropriate, in order to facilitate understanding of the parts. Further, in each of the figures, illustration of some of the parts that may be considered unimportant in describing embodiments is omitted for the sake of convenience.

<Configuration of Disk Drive Unit>

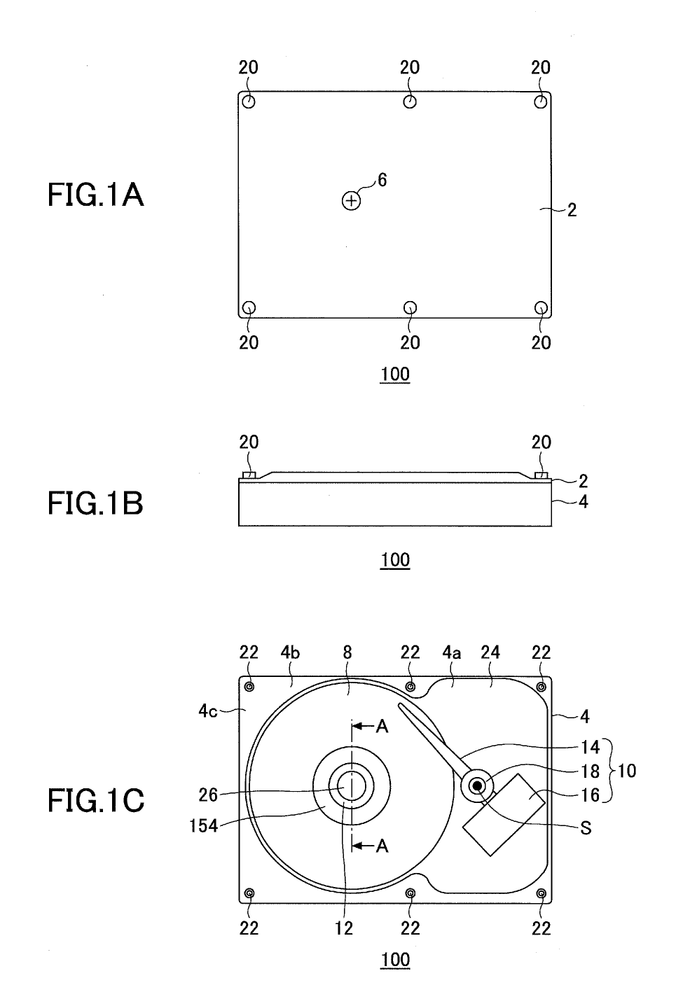

A description will be given of a configuration of a disk drive unit 100, which is an example of a rotating device in an embodiment, by referring to FIGS. 1A, 1B, and 1C. FIGS. 1A, 1B, and 1C illustrate the disk drive unit 100 in this embodiment. FIG. 1A illustrates a top view (or plan view) of the disk drive unit 100, FIG. 1B illustrates a side view of the disk drive unit 100, and FIG. 1C illustrates a top view of the disk drive unit 100 in a state in which a top cover 2 is removed.

The disk drive unit 100 includes the top cover 2 and a base 4. A magnetic recording disk 8 and a data read and write part 10 are provided in a space between the top cover 2 and the base 4.

In the following description, in a state in which the top cover 2 is mounted on the base 4, an end (or side) of the top cover 2 may also be referred to as an upper end (or upper side), and an end (or side) of the base 4 may also be referred to as a lower end (or lower side) of the disk drive unit 100.

(Base)

As illustrated in FIG. 1C, the base 4 includes a bottom plate part 4a that forms a bottom part of the disk drive unit 100, and an outer peripheral wall part 4b that is formed along an outer periphery of the bottom plate part 4a so as to surround a mounting region in which the magnetic recording disk 8 is to be mounted. An upper surface 4c of the outer peripheral wall part 4b includes six (6) screw holes 22 that are used to mount the top cover 2.

The base 4 in this embodiment may be formed by die casting an aluminum alloy, however, the method of forming the base 4 is not limited to such a method. For example, the base 4 may be formed by pressing a metal plate, such as an aluminum plate, a steel plate, and the like. In this latter case, an embossing may be performed in order to form projections on the upper side of the base 4. By performing the embossing at predetermined parts of the base 4, deformation of the base 4 may be suppressed.

In addition, when forming the base 4 by the pressing, a surface treatment, such as plating, resin coating, and the like may be performed on the base 4. For example, after forming the base 4 by pressing the metal plate, a nickel plated layer and an epoxy resin surface layer may be provided on the base 4.

In addition, the base 4 may be formed by a combination of a metal plate part that is formed by pressing the metal plate, such as the aluminum plate, the steel plate, and the like, and a die cast part that is formed by aluminum die casting. For example, the bottom plate part 4a may be formed to include the metal plate part, and the outer peripheral wall part 4b may be formed to include the die cast part. By employing this combination configuration, rigidity deterioration of the screw holes 22 can be suppressed. In this case, the die cast part may be formed by the aluminum die casting in a state in which the preformed metal plate part is set in a die that is used for the aluminum die casting. According to this method of manufacturing the base 4, a process to connect the metal plate part and the die cast part can be omitted, and a dimension accuracy of the metal plate part and the die cast part can be improved. Further, a separate part or member used to connect the metal plate member and the die cast part can be reduced or eliminated, and as a result, the base 4 can be made thin.

(Top Cover)

As illustrated in FIGS. 1A and 1B, the top cover 2 is fixed to the upper surface 4c of the outer peripheral wall part 4b of the base 4, by screwing six (6) screws into the screw holes 22 that are provided in the upper surface 4c of the base 4. In addition, a shaft 26 is fixed to a lower surface of the base 4 by a shaft securing screw 6.

(Disk Accommodating Space)

A disk accommodating space 24 is formed between the top cover 2 and the base 4. The disk accommodating space 24 accommodates the magnetic recording disk 8. The disk accommodating space 24 may be filled with clean air removed of dust, in order to prevent contaminating particles from adhering onto the surface of the magnetic recording disk 8 and to improve the reliability of the operation of the disk drive unit 100. Accordingly, the top cover 2 and the base 4 are provided to seal the disk accommodating space 24 so that the dust does not enter the disk accommodating space 24 from the atmosphere.

(Magnetic Recording Disk)

The magnetic recording disk 8 is set on a hub (not illustrated) that surrounds the shaft 26, and rotates together with the hub. For example, the magnetic recording disk 8 may be formed by a 2.5-inch type magnetic recording disk made of glass and having a diameter of 65 mm, a thickness of 0.65 mm, and a center hole with a diameter of 20 mm. In this example, four (4) magnetic recording disks 8 may be accommodated within the disk drive unit 100.

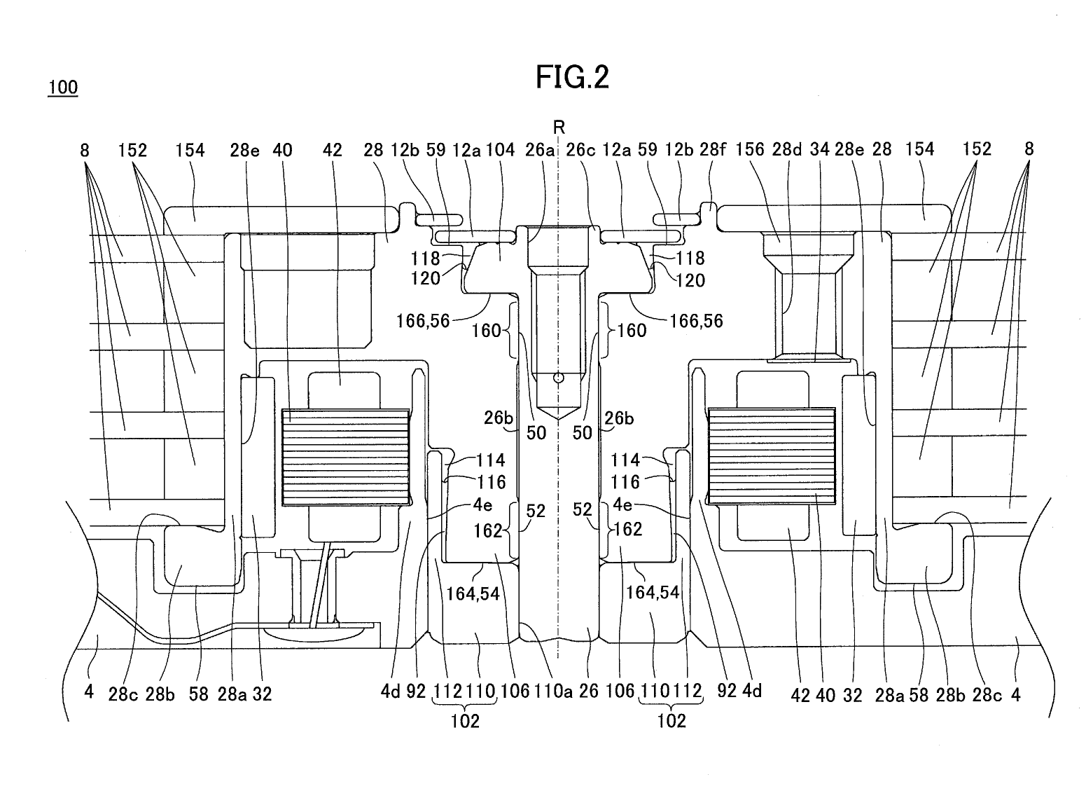

The magnetic recording disk 8 is pushed by a clamper 154 against the hub together with a spacer (not illustrated), and fixed to the hub. Hence, the magnetic recording disk 8 can rotate together with the hub about the shaft 26 as its center of rotation. A cap 12 (including caps 12a and 12b to be described later in conjunction with FIG. 2) can suppress the lubricant that is provided between the shaft 26 and a sleeve (not illustrated) that surrounds the shaft 26 from scattering into the disk accommodating space 24.

(Data Read and Write Part)

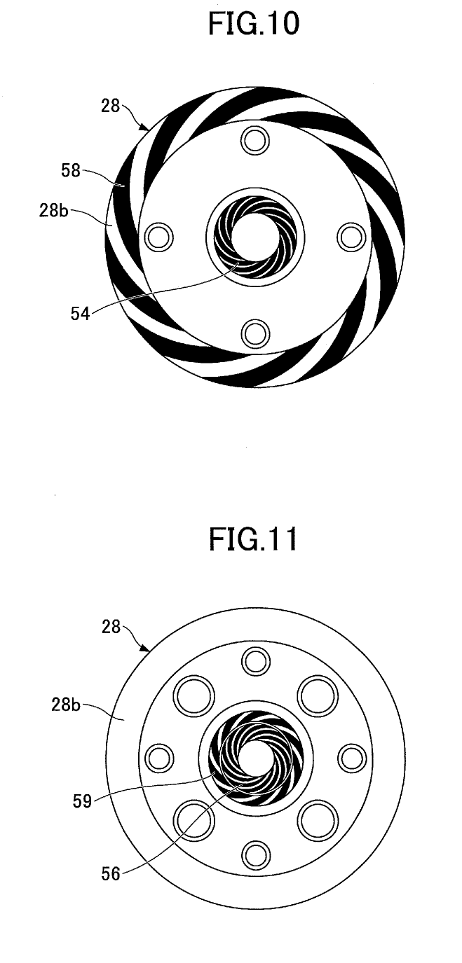

The data read and write part 10 includes a recording and reproducing head (not illustrated), a swing arm 14, a voice coil motor 16, and a pivot assembly 18, as illustrated in FIG. 10.

The recording and reproducing head is mounted on a tip end of the swing arm 14, and records (or writes) data to the magnetic recording disk 8 and reproduces (or reads) data from the magnetic recording disk 8.

The pivot assembly 18 pivotally supports the swing arm 14 with respect to the base 4 about a head rotational axis S as its center of pivoting.

The voice coil motor 16 swings the swing arm 14 about the head rotational axis S as its center of swing, and moves the recording and reproducing head to a desired position on an upper surface of the magnetic recording disk 8. The voice coil motor 16 and the pivot assembly 18 may be formed using a known technique to control the head position.

<Configuration of Bearing Mechanism>

A description will be given of a bearing mechanism of the disk drive unit 100, by referring to FIG. 2. FIG. 2 illustrates a cross sectional view of the disk drive unit 100 along a line A-A in FIG. 1G. In the following description, a direction perpendicular to a rotational axis R may also be referred to as a radial direction, an end (or side) further away from the rotational axis R along a radial direction of the magnetic recording disk 8 may also be referred to as an outer peripheral side, and an end (or side) closer to the rotational axis R along the radial direction may also be referred to as an inner peripheral side.

The disk drive unit 100 includes a rotor that is set with the magnetic recording disk 8 and rotates, and a fixed body that rotatably supports the rotor. The fixed body forms an example of a bearing mechanism.

The rotor includes a hub 28 that includes a sleeve 106, a cylindrical magnet 32, and the clamper 154. The fixed body includes the base 4, the shaft 26, a laminated core 40, a coil 42, and a housing 102. The sleeve 106 of the hub 28 surrounds the shaft 26, and the hub 28 rotates while being supported by the shaft 26 and the housing 102. A lubricant 92 is provided between the shaft 26 and the sleeve 106. In addition, a fluid dynamic pressure generating part that generates a fluid dynamic pressure in the lubricant 92 is provided between the shaft 26 and the sleeve 106.

(Hub)

The hub 28 includes the sleeve 106, a hub projecting part 28a that fits into the center hole of the magnetic recording disk 8, a disk setting part 28c provided on the outer peripheral side of the hub projecting part 28a, and a disk setting surface 28c on which the magnetic recording disk 8 is set.

Four (4) stacked magnetic recording disks 8 having a ring-shaped spacer 152 interposed between each of two (2) mutually adjacent magnetic recording disks 8 are set on the disk setting surface 28c of the hub projecting part 28a. The magnetic recording disks 8 are fixed to the hub projecting part 28a of the hub 28 together with the spacers 152, by being sandwiched between the clamper 154 and the disk setting part 28b, and rotate together with the hub 28.

The hub 28 may be formed from a soft magnetic stainless steel material such as SUS430F, for example. The hub 28 may be formed integrally with the sleeve 106 by pressing or cutting the stainless steel material. Accordingly, the rotor integrally includes the hub 28 and the sleeve 106.

The steel material preferably used for the hub 28 may be stainless steel DHS1 supplied by Daido Steel Co., Ltd., for example, which is low in outgas and easy to press and cut. In addition, the steel material used for the hub 28 may be stainless steel DHS2 supplied by Daido Steel Co., Ltd., for example, which may further be preferable due to its anti-corrosion characteristic. A surface treatment, such as plating, resin coating, and the like may be performed on the hub 28. The hub 28 in this embodiment may include a surface layer formed by electroless nickel plating, in order to suppress peeling of micro residue adhered on the processed surface.

The sleeve 106 of the hub 28 surrounds the shaft 26, and is sandwiched between a flange surrounding part 104 of the shaft 26 and a shaft holding part 110 of the housing 102 along an axial direction. The sleeve 106 surrounds the shaft 26 from the upper part of the shaft 26 held by the shaft holding part 110 of the housing 102 to the flange surrounding part 104 of the shaft 26. The lubricant 92 is provided between the sleeve 106 and the shaft 26.

A first air flow generating groove 58 having a herringbone shape or a spiral shape, for example, is formed in the lower surface of the disk setting part 28b of the hub 28. The first air flow generating groove 58 is formed to generate an air flow in a direction towards the inner peripheral side with respect to the air existing between the disk setting part 28b of the hub 28 and the base 4, when the hub 28 rotates. The first air flow generating groove 58 can reduce the scattering of the lubricant 92 into the disk accommodating space 24.

The first air flow generating groove 58 may be formed in a part of the base 4 opposing the lower surface of the disk setting part 28b. The first air flow generating groove 58 in this case similarly generates an air flow in the direction towards the inner peripheral side with respect to the air existing between the disk setting part 28b of the hub 28 and the base 4, when the hub 28 rotates. Hence, the first air flow generating groove 58 can reduce the scattering of the lubricant 92 into the disk accommodating space 24.

(Clamper)

The clamper 154 is fixed to an upper surface of the hub 28 by a plurality of clamp screws 156. The clamp screws 156 are screwed into clamp screw holes 28d provided in the hub 28, in order to fix the clamper 154 to the hub 28. The clamp screw holes 28d penetrate the hub 28, and a lower end of the clamp screw holes 28d are closed by a closing means 34 such as a tape, for example. Because the clamp screw holes 28d have a shape penetrating the hub 28, the clamp screw holes 28d may be formed with ease. In addition, because the closing means 34 may close the clamp screw holes 28d, upward scattering of the lubricant 92 through the clamp screw holes 28d can be prevented.

(Cylindrical Magnet)

The cylindrical magnet 32 is bonded and fixed to a cylindrical inner peripheral surface 28e on the inner peripheral side of the hub projecting part 28a of the hub 28. The cylindrical magnet 32 may be formed from a rare earth magnetic material, a ferrite magnetic material, or the like, for example. The cylindrical magnet 32 in this embodiment may be formed from a neodymium rare earth magnetic material.

The cylindrical magnet 32 is magnetized to have sixteen (16) poles, for example, along a circumferential direction of a circle about the rotational axis R as its center in a cross section perpendicular to the rotational axis R. A surface layer is formed on the surface of the cylindrical magnet 32 by electro-coating, spray coating, or the like, for example, in order to suppress corrosion. The cylindrical magnet 32 opposes twelve (12) salient poles of the laminated core 40 in the radial direction.

(Laminated Core)

The laminated core 40 includes a cylindrical part and the twelve (12) salient poles extending from the cylindrical part towards the outer peripheral side. The laminated core 40 may be formed by laminating fourteen (14) thin magnetic steel plates, and crimping or caulking the thin magnetic steel plates in order to integrally form the laminated core 40. An insulator coating is formed on the surface of the laminated core 40 by electro-coating, powder coating, or the like, for example. The coil 42 is wound on each salient pole of the laminated core 40. A driving magnetic flux is generated along the salient poles when a 3-phase driving current having an approximately sinusoidal waveform flows to the coil 42.

A cylindrical base projecting part 4d having the rotational axis R as its center is provided on the base 4. The base projecting part 4d surrounds the housing 102 and projects upwards from the lower surface of the base 4. The laminated core 40 is fitted over the outer peripheral surface of the base projecting part 4d, so that the outer peripheral surface of the base projecting part 4d fits into a center hole in the cylindrical part of the laminated core 40. The cylindrical part of the laminated core 40 may be press fit, or bonded, or press fit and bonded to the base projecting part 4d.

The core is not limited to the laminated core 40, and for example, a solid core may be used in place of the laminated core 40. In addition, although the disk drive unit 100 in this embodiment is the so-called outer rotor type in which the cylindrical magnet 32 is located on the outer side of the laminated core 40, the disk drive unit 100 may be the so-called inner rotor type in which the cylindrical magnet 32 is located on the inner side of the laminated core 40.

(Housing)

The housing 102 includes the flat ring-shaped shaft holding part 110, and cylindrical part 112 that projects upwards from the outer peripheral side of the shaft holding part 110. The cylindrical part 112 surrounds the lower end part at the outer periphery of the sleeve 106 on the side of the base 4. The lubricant 92 is provided between the cylindrical part 112 of the housing 102 and the outer peripheral surface of the sleeve 106.

The housing 102 may be formed by connecting the shaft holding part 110 and the cylindrical part 112 that are formed as separate parts. By forming the housing 102 from separate parts, each of the shaft holding part 110 and the sleeve surrounding part 112 can be formed with ease. On the other hand, when the shaft holding part 110 and the cylindrical part 112 are formed integrally as in this embodiment, a manufacturing error can be reduced and a bonding process can be simplified.

The housing 102 is fixed to the base 4 by press fitting, or bonding, or press fitting and bonding the cylindrical part 112 into a center hole 4e that is provided on the inner peripheral side of the base projecting part 4d and has the rotational axis R as its center. The shaft holding part 110 of the housing 102 includes a shaft hole 110a having the rotational axis R as its center, and the shaft 26 is press fit, or bonded, or press fit and bonded into the shaft hole 110a in order to fix and hold the shaft 26.

The housing 102 may be formed from a copper alloy, a sintered alloy made by powder metallurgy, stainless steel, plastic materials such as polyetherimide, polyimide, and polyamide, or the like, for example. In a case in which the plastic material is used for the housing 102, carbon fiber may be included in the plastic material to make the resistivity 10⁶ (Ω·m) or less, in order to ensure an electrostatic eliminating function of the disk drive unit 100.

(Shaft)

The shaft 26 includes a securing screw hole 26a at an upper surface thereof. An upper end of the shaft 26 is fixed to the cover 2 by screwing the shaft securing screw 6 into the securing screw hole 26a by penetrating the top cover 2. In addition, a lower end of the shaft 26 is press fit, or bonded, or press fit and bonded into the shaft hole 110a of the housing 102 and fixed to the housing 102. The disk drive unit 100 has a superior shock resistance and vibration resistance due to the structure in which both ends of the shaft 26 are fixed to and supported by the top cover 2 and the housing 102.

A flange surrounding part 104 is provided at the upper end side of the shaft 26. The flange surrounding part 104 may be formed as a separate part from the shaft 26. The flange surrounding part 104 and the shaft 26 can be formed with ease by forming the flange surrounding part 104 and the shaft 26 as separate parts. In this embodiment, the shaft 26 and the flange surrounding part 104 is formed integrally. When the shaft 26 and the flange surrounding part 104 are formed integrally as in this embodiment, the strength and the dimension accuracy of the flange surrounding part 104 can be improved. The shaft 26 may be formed by cutting stainless steel such as SUS420J2 or the like, for example.

(Dynamic Pressure Generator)

A first gap is formed between an outer peripheral surface 26b of the shaft 26 and the inner peripheral surface of the sleeve 106. The lubricant 92 is provided in this first gap.

In the first gap, a first radial dynamic pressure generator 160 is formed at a lower part of the flange surrounding part 104 of the shaft 26, and a second radial dynamic pressure generator 162 is formed at an upper part of the shaft holding part 110 of the housing 102. The first radial dynamic pressure generator 160 and the second radial dynamic pressure generator 162 are formed at positions separated along the direction of the rotational axis (or axial direction).

The sleeve 106 includes a first radial dynamic pressure generating groove 50 having a herringbone shape or a spiral shape, for example, at a part opposing the first radial dynamic pressure generator 160. In addition, the sleeve 106 includes a second radial dynamic pressure generating groove 52 having a herringbone shape or the spiral shape, for example, at a part opposing the second radial dynamic pressure generator 162.

One of or both the first radial dynamic pressure generating groove 50 and the second radial dynamic pressure generating groove 52 may be formed on the outer peripheral surface 26b of the shaft 26.

A second gap is formed between a lower surface 106a of the sleeve 106 and an upper surface 110b of the shaft holding part 110 of the housing 102. The lubricant 92 is provided in this second gap, in a manner similar to the first gap.

In the second gap, a first thrust dynamic pressure generator 164, that generates a dynamic pressure in the lubricant 92 along the direction of the rotational axis, is formed when the hub 28 including the sleeve 106 rotates. The sleeve 106 includes a first thrust dynamic pressure generating groove 54 having a herringbone shape or a spiral shape, for example, in a lower surface opposing the first thrust dynamic pressure generator 164. The first thrust dynamic pressure generating groove 54 may be formed in the upper surface of the shaft holding part 110, instead of being formed in the lower surface of the sleeve 106.

A third gap is formed between the upper surface of the sleeve 106 and a lower surface of the flange surrounding part 104 of the shaft 26. The lubricant 92 is provided in this third gap, in a manner similar to the first and second gaps.

In the third gap, a second thrust dynamic pressure generator 166, that generates a dynamic pressure in the lubricant 92 along the direction of the rotational axis, is formed when the hub 28 including the sleeve 106 rotates. The sleeve 106 includes a second thrust dynamic pressure generating groove 56 having a herringbone shape or a spiral shape, for example, in the upper surface opposing the second thrust dynamic pressure generator 166. The second thrust dynamic pressure generating groove 56 may be formed in the lower surface of the flange surrounding part 104, instead of being formed in the upper surface of the sleeve 106.

When the sleeve 106 and the hub 28 rotate with respect to the shaft 26, the dynamic pressure is generated in the lubricant 92 at each of the first radial dynamic pressure generator 160, the second radial dynamic pressure generator 162, the first thrust dynamic pressure generator 164, and the second thrust dynamic pressure generator 166. The sleeve 106 is supported along the radial direction and the direction of the rotational axis by the dynamic pressure generated in the lubricant 92, in a non-contact state in which no contact is made with the shaft 26 and the housing 102.

The sleeve 106 may include a bypass communicating hole that bypasses the first thrust dynamic pressure generator 164 and the second thrust dynamic pressure generator 166. By providing the bypass communicating hole, a pressure difference amongst regions of the lubricant 92 can be reduced, to thereby stabilize the behavior of the lubricant 92.

(Gas-Liquid Interface)

A first gas-liquid interface 116 of the lubricant 92 is formed between the outer peripheral surface of the sleeve 106 and an inner peripheral surface of the cylindrical part 112 of the housing 102. A first tapered seal 114, that has an interval gradually spreading in an upward direction, is provided between the outer peripheral surface of the sleeve 106 and the inner peripheral surface of the cylindrical part 112.

In addition, a second gas-liquid interface 120 of the lubricant 92 is formed between an outer peripheral surface of the flange surrounding part 104 of the sleeve 106 and an inner peripheral surface of the hub 28 opposing the flange surrounding part 104. A second tapered seal 118, that has an interval gradually spreading in the upward direction, is provided between the outer peripheral surface of the flange surrounding part 104 and the inner peripheral surface of the hub 28.

(Cap)

The caps 12a and 12b, formed by ring-shaped members, are provided to cover a gap between the hub 28 and the shaft 26, in a space which communicates from the second gas-liquid interface 120 of the lubricant 92 to the disk accommodating space 24 in which the magnetic recording disks 8 are accommodated. The ring-shaped caps 12a and 12b are provided to overlap in the direction of the rotational axis of the hub 28 and the sleeve 106.

The cap 12a is fit on a projecting part 26c on the upper end of the shaft 26, and is provided on the upper surface of the flange surrounding part 104 of the shaft 26. The cap 12a covers the second gas-liquid interface 120 that is formed at the gap between the outer peripheral surface of the flange surrounding part 104 and the inner peripheral surface of the hub 28, in order to prevent the lubricant 92 from scattering from the second gas-liquid interface 120 into the disk accommodating space 24 and adhering onto the surface of the magnetic recording disk 8.

The narrower the gap between the cap 12a and the hub 28, the smaller the amount of the lubricant 92 scattering into the disk accommodating space 24, but the higher the possibility of the cap 12a making contact with the hub 28. Accordingly, the gap between the cap 12a and the hub 28 is appropriately set a value so that the amount of the lubricant 92 scattering into the disk accommodating space 24 is reduced and the cap 12a does not make contact with the hub 28. For example, the gap between the cap 12a and the hub 28 in the radial direction is set in a range of 0.01 mm to 0.2 mm. The cap 12b is fit on an upper surface projecting part 28f of the hub 28, and is provided above the cap 12a in the axial direction. The cap 12b covers a gap between the cap 12a and the hub 28, and prevents the lubricant 92 scattering from the second gas-liquid interface 120 from passing through the gap between the cap 12a and the hub 28 and reaching the disk accommodating space 24.

The narrower the gap between the cap 12a and the cap 12b in the axial direction, the smaller the amount of the lubricant 92 scattering into the disk accommodating space 24, but the higher the possibility of the cap 12a and the cap 12b making contact with each other. Accordingly, the gap between the cap 12a and the cap 12b is appropriately set to a value so that the amount of scattering of the lubricant 92 into the disk accommodating space 24 is reduced and the cap 12a and the cap 12b do not make contact with each other. For example, the gap between the cap 12a and the cap 12b in the axial direction is set in a range of 0.01 mm to 0.2 mm.

Each of the caps 12a and 12b may be formed by a metal material such as SUS304, DHS1, steel alloy, and the like, a resin material, or the like. In addition, at least one of the caps 12a and 12b, or at least a part of the caps 12a and 12b, may be formed by a porous material such as sintered metal, activated carbon including activated charcoal, or the like. The porous material can capture the vaporized lubricant 92 in pores thereof, in order to further reduce the amount of the lubricant 92 scattering into the disk accommodating space 24.

A second air flow generating groove 59 having a herringbone shape or a spiral shape, for example, may be formed in a part of the upper surface of the hub 28 opposing the cap 12a. The second air flow generating groove 59 is formed to generate an air flow in a direction towards the inner peripheral side with respect to the air existing between the cap 12a and the hub 28, when the hub 28 rotates. The second air flow generating groove 59 can further reduce the scattering of the lubricant 92 into the disk accommodating space 24.

The second air flow generating groove 59 may be formed in the lower surface of the cap 12a. The second air flow generating groove 59 in this case similarly generates an air flow in the direction towards the inner peripheral side with respect to the air existing between the cap 12a and the hub 28, when the hub 28 rotates. Hence; the second air flow generating groove 59 can further reduce the scattering of the lubricant 92 into the disk accommodating space 24.

A third air flow generating groove having a herringbone shape or a spiral shape, for example, may be formed in one of or both the upper surface of the cap 12a and the lower surface of the cap 12b at a part where the cap 12a and the cap 12b oppose each other along the axial direction. The third air flow generating groove forms an air flow generating part between the cap 12a and the cap 12b. The third air flow generating groove may be formed to generate an air flow in the direction towards the outer peripheral side with respect to the air existing between the cap 12a and the hub 28. Hence, the third air flow generating groove can further reduce the scattering of the lubricant 92 into the disk accommodating space 24.

<Dynamic Pressure Generating Groove and Method of Forming Air Flow Generating Groove>

Next, a description will be given of a method of forming the first radial dynamic pressure generating groove 50, the second radial dynamic pressure generating groove 52, the first thrust dynamic pressure generating groove 54, the second thrust dynamic pressure generating groove 56, the first air flow generating groove 58, and the second air flow generating groove 59.

(Cutting Apparatus)

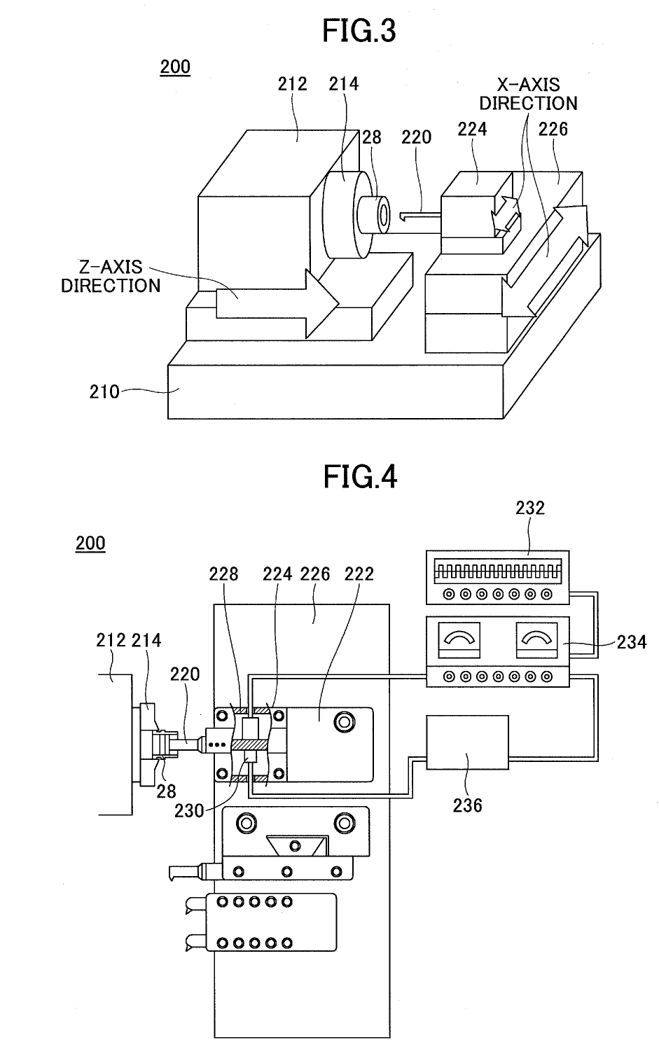

FIG. 3 is a diagram generally illustrating a cutting apparatus 200 that cuts the outer peripheral surface of the hub 28 and forms the groove, such as the first radial dynamic pressure generating groove 50, in the hub 28.

The cutting apparatus 200 includes a base 210 and a rotational driving part 212 provided on the base 210. The rotational driving part 212 holds the hub 28 of the disk drive unit 100 by a chuck 214, and rotates the hub 28. The rotational driving part 212 rotates the hub 28 at a rotational speed of 400 rpm (revolutions per minute) to 12000 rpm, for example. The rotational speed of the rotational driving part 212 may be appropriately set according to the material and size of the hub 28, the shape of the groove, and the like.

FIG. 4 is a plan view generally illustrating the cutting apparatus 200. As illustrated in FIG. 4, the cutting apparatus 200 includes a tool bit holding part 222 which holds a tool bit 220 at a position on an extension of the rotation center of the hub 28, and thus the tool bit 220 cuts the hub 28.

As illustrated in FIG. 3, the direction of the rotational axis of the hub 28 is a Z-axis direction, and a direction in which the tool bit holding part 222 is displaced is an X-axis direction perpendicular to the Z-axis direction.

In the cutting apparatus 200, the rotational driving part 212 is provided movable in the Z-axis direction. In addition, the cutting apparatus 200 includes a first driving part 224 that moves the tip end of the tool bit 220 in the X-axis direction by extremely small amounts, and a second driving part 226 that moves the first driving part 224 mounted thereon in the X-axis direction.

As illustrated in FIG. 4, a piezoelectric element 228 is provided in the first driving part 224, as a driving source. The piezoelectric element 228 is connected to a pulse generator 232 and a driving power supply 234, and displaces the tool bit 220 in the X-axis direction when driven by an alternating electric field whose period and phase are controlled, for example.

In addition, an electrostatic capacitance type displacement sensor 230 to detect the driven displacement of the piezoelectric element 228 is provided in the first driving part 224. The first driving part 224 includes a displacement sensor controller 236 that performs a feedback control with respect to the driving power supply 234 based on an output of the displacement sensor 230. The displacement sensor controller 236 can constantly control the position of the tool bit 220 with a high accuracy regardless of an environmental change, by controlling the driving power supply 234 based on the output of the displacement sensor 230.

The second driving part 226 includes a servo motor or the like as a driving source, for example. The second driving part 226 can move in the X-axis direction together with the first driving part 224. The cutting apparatus 200 moves the tool bit 220 to a cutting position on the hub 28 by the first driving part 224 and the second driving part 226.

Furthermore, the cutting apparatus 200 may include a rotation reference position detector to detect a rotation reference position of the hub 28, an encoder to detect a rotation angle of the hub 28, a tool bit position detector to detect the position of the tool bit 220, and the like. In addition, the cutting apparatus 200 may include a controller to control the period and phase of the alternating electric field to be applied to the piezoelectric element 228, according to outputs of the rotation reference position detector, the encoder, and the tool bit position detector, in order to enable cutting at an even higher accuracy.

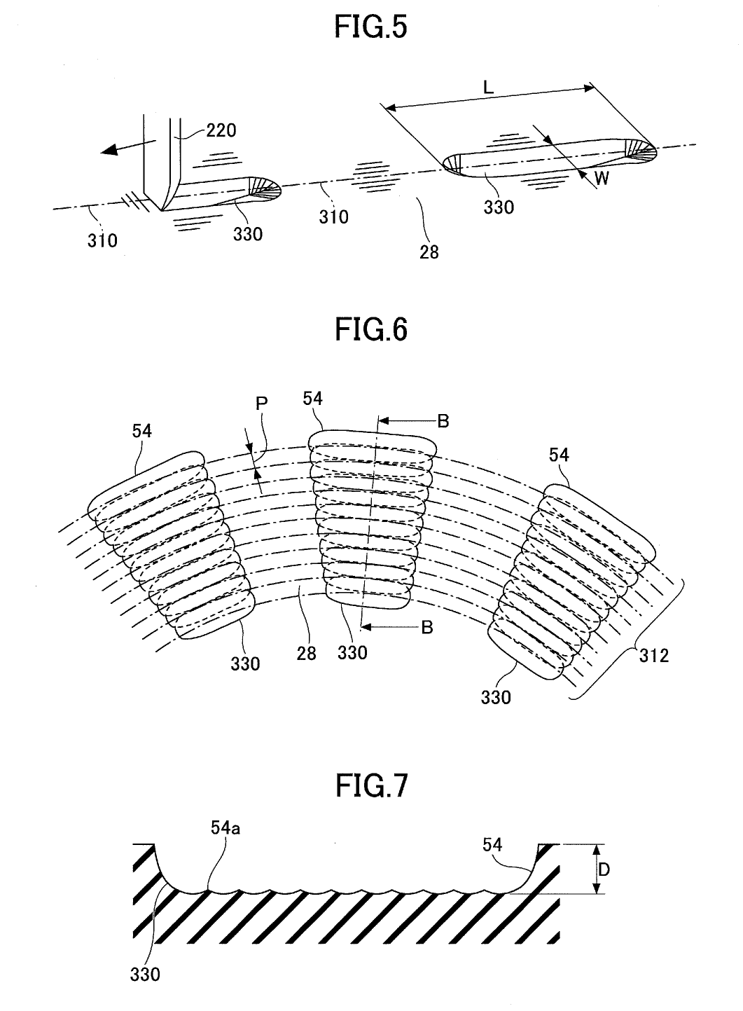

FIG. 5 schematically illustrates a state in which the tool bit 220 forms a groove in the hub 28.

Because the hub 28 is rotated along a rotating direction 310 by the rotational driving part 212, the tool bit 220 moves in a direction indicated by an arrow in FIG. 5 relative to the hub 28. In addition, by applying the alternating electric field to the piezoelectric element 228 of the first driving part 224, the tool bit 220 is displaced in upward and downward directions in FIG. 5, and the tool bit 220 cuts a desired position of the rotating hub 28 to form discontinuous (or intermittent) pits 330.

FIG. 6 is a diagram schematically illustrating, on an enlarged scale, an example of a part of the first thrust dynamic pressure generating groove 54 having the spiral shape formed in the hub 28 by the cutting apparatus 200.

As illustrated in FIG. 6, the tool bit 220 cuts the rotating hub 28 while moving in the X-axis direction at a predetermined pitch P, in order to form the first thrust dynamic pressure generating groove 54 by cutting the discontinuous pits 330 along a spiral line 312 so that the discontinuous pits 330 are aligned in the radial direction.

FIG. 7 is a diagram illustrating a cross section of the first thrust dynamic pressure generating groove 54 along a line B-B in FIG. 6.

As illustrated in FIG. 7, the first thrust dynamic pressure generating groove 54 includes a circumferential direction striated projecting part 54a that extends in the circumferential direction at a boundary between two mutually adjacent discontinuous pits 330 that are mutually adjacent in the radial direction of the hub 28. When the hub 28 rotates with respect to the shaft 26, the circumferential direction striated projecting parts 54a adjust and align the direction in which the lubricant 92 flows in order to suppress the rotation resistance from increasing considerably.

A width W of the discontinuous pit 330 in a direction perpendicular to the rotating direction 310 of the hub 28 in FIG. 5 is set in a range of 0.02 mm to 0.2 mm, for example. In addition, a length L of the discontinuous pit 330 in the rotating direction 310 of the hub 28 is set in a range of 0.2 mm to 2 mm, for example. The pitch P of the discontinuous pits 330 in FIG. 6 is set in a range of 5 μm to 30 μm, for example. A depth D of the discontinuous pit 330 in FIG. 7 is set in a range of 3 μm to 50 μm, for example.

In the example described above, the first thrust dynamic pressure generating groove 54 has the spiral shape. However, the cutting process may be performed in a similar manner when forming the first thrust dynamic pressure generating groove 54 having a herringbone shape, by continuously forming the discontinuous pits 330 in the radial direction.

In addition, the second thrust dynamic pressure generating groove 56, the first radial dynamic pressure generating groove 50, the second radial dynamic pressure generating groove 52, the first air flow generating groove 58, the second air flow generating groove 59, and the third air flow generating groove can be formed in a similar manner to have the spiral shape or the herringbone shape with wavy undulations at a bottom surface of the groove by the discontinuous pits 330 that are continuously formed by the wavy cutting process described above.

(Cutting Process)

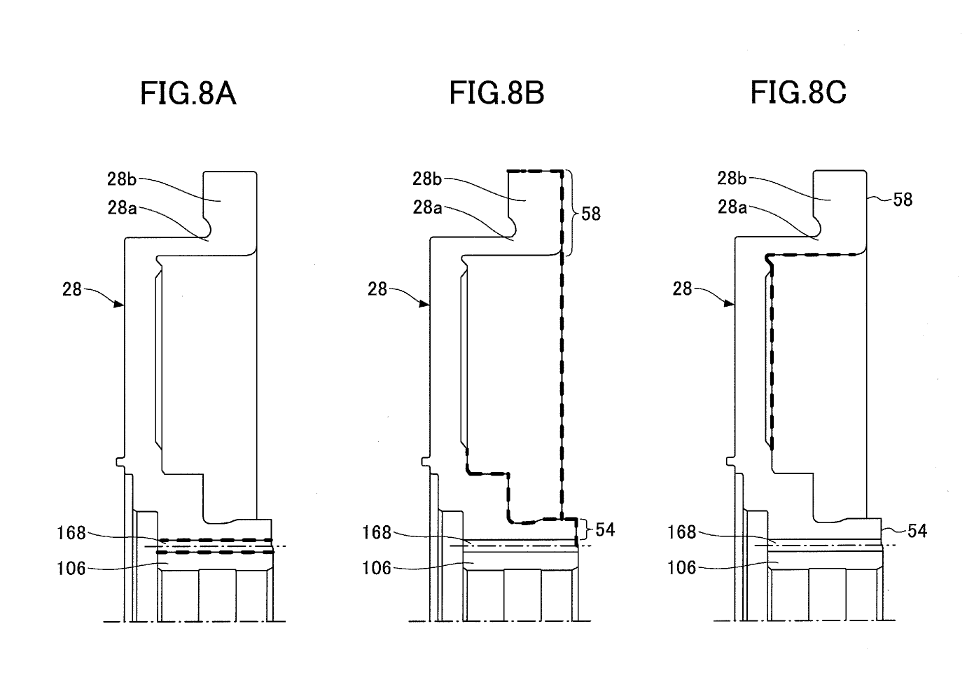

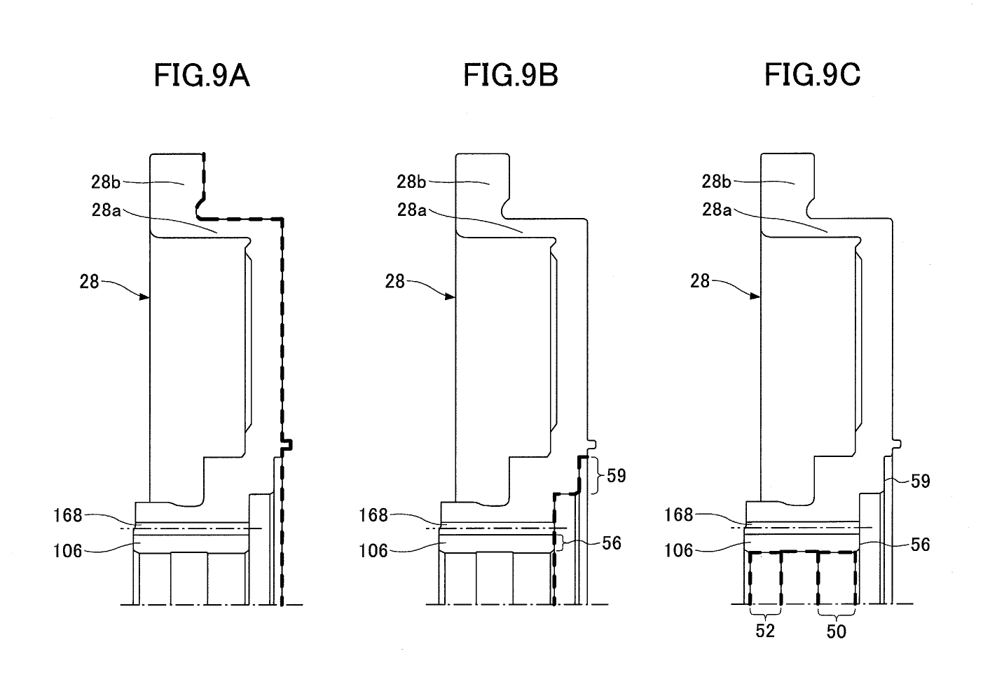

Next, a description will be given of the cutting process of the cutting apparatus 200 with respect to the hub 28, by referring to FIGS. 8A through 8C and FIGS. 9A through 9C. In FIGS. 8A through 8C and FIGS. 9A through 9C, a bold dotted line indicates a position where the cutting apparatus 200 performs the cutting process with respect to the hub 28.

The hub 28 is fixed on the chuck 214 so that a cutting surface of the hub 28 to be cut opposes the tool bit 220, and the cutting apparatus 200 performs the cutting in an order illustrated in FIGS. 8A through 8C, for example.

First, a bypass communication hole 168 that penetrates the lower surface side and the upper surface side of the sleeve 106 of the hub 28 along the direction of the rotational axis is formed as illustrated in FIG. 8A. The bypass communication hole 168 reduces a pressure difference between the pressure applied to the lubricant 92 existing between the sleeve 106 and the shaft 26 and the pressure applied to the lubricant 92 existing between the sleeve 106 and the housing 102, in order to stabilize the behavior of the lubricant 92.

Next, the lower surface side of the hub 28 is cut, and at this stage, the first air flow generating groove 58 is formed in the lower surface of the disk setting part 28b and the hub projecting part 28a, and the first thrust dynamic pressure generating groove 54 is formed in the lower surface side of the sleeve 106, as illustrated in FIG. 8B. In this embodiment, the first thrust dynamic pressure generating groove 54 and the first air flow generating groove 58 are both cut into the spiral shape.

Next, a finishing process is performed with respect to the remaining uncut part of the lower surface side of the hub 28, as illustrated in FIG. 8C.

When the cutting process with respect to the lower surface side of the hub 28 ends, the hub 28 is fixed to the chuck 214 so that the upper surface side of the hub 28 to be cut opposes the tool bit 220, and the cutting apparatus 200 performs the cutting in an order illustrated in FIGS. 9A through 9C, for example.

First, the cutting apparatus 200 cuts the upper surface side outer peripheral surface of the hub 28, as illustrated in FIG. 9A.

Next, the upper surface of the sleeve 106 and a part of the sleeve 106 including the surface opposing the cap 12a are cut, as illustrated in FIG. 9B. At this stage, the second thrust dynamic pressure generating groove 56 is formed in the upper surface of the sleeve 106, and the second air flow generating groove 59 is formed in the surface of the sleeve 106 opposing the cap 12a. In this embodiment, the second thrust dynamic pressure generating groove 56 and the second air flow generating groove 59 are both cut into the spiral shape.

Next, the inner peripheral surface of the sleeve 106 is cut, and at this stage, the first radial dynamic pressure generating groove 50 and the second radial dynamic pressure generating groove 52 are formed as illustrated in FIG. 9C. In this embodiment, the first radial dynamic pressure generating groove 50 and the second radial dynamic pressure generating groove 52 are both cut into the herringbone shape.

(Dynamic Pressure Generating Groove and Air Flow Generating Groove)

FIG. 10 is a diagram illustrating an example of the first thrust dynamic pressure generating groove 54 and the first air flow generating groove 58 formed in a bottom surface of the hub 28 by the cutting process.

As illustrated in FIG. 10, the first thrust dynamic pressure generating groove 54 having the spiral shape is formed in the bottom surface of the hub 28, at a position of the lower surface of the sleeve 106 opposing the upper surface of the shaft holding part 110 of the housing 102. In addition, the first air flow generating groove 58 having the spiral shape is formed in the lower surface of the disk setting part 28b.

The first thrust dynamic pressure generating groove 54 and the first air flow generating groove 58 are both cut by the cutting apparatus 200, and have the wavy undulations at the bottom surface of the groove.

FIG. 11 is a diagram illustrating an example of the second thrust dynamic pressure generating groove 56 and the second air flow generating groove 59 formed in an upper surface of the hub 28 by the cutting process.

As illustrated in FIG. 11, the second thrust dynamic pressure generating groove 56 having the spiral shape is formed in the upper surface side of the hub 28, at a position of the upper surface of the sleeve 106 opposing the lower surface of the flange surrounding part 104 of the shaft 26. In addition, the second air flow generating groove 59 having the spiral shape is formed in the upper surface side of the hub 28, at a position opposing the lower surface of the cap 12a that is fixed on the upper surface of the flange surrounding part 104 of the shaft 26.

The second thrust dynamic pressure generating groove 56 and the second air flow generating groove 59 are both cut by the cutting apparatus 200, and have the wavy undulations at the bottom surface of the groove.

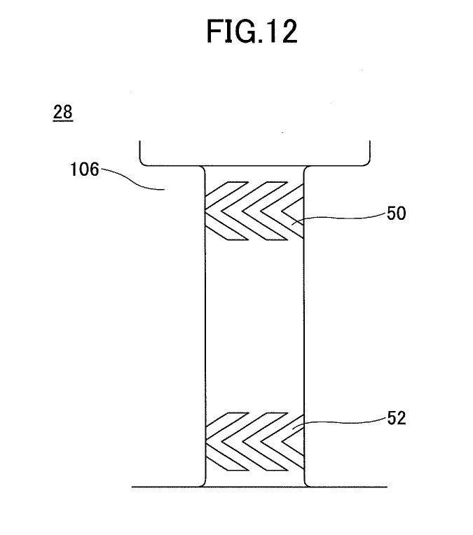

FIG. 12 is a diagram illustrating an example of the first radial dynamic pressure generating groove 50 and the second radial dynamic pressure generating groove 52 formed in the inner peripheral surface of the sleeve 106.

The first radial dynamic pressure generating groove 50 and the second radial dynamic pressure generating groove 52 respectively having the herringbone shape are formed in the inner peripheral surface of the sleeve 106 of the hub 28, at positions separated along the direction of the rotational axis.

The first dynamic pressure generating groove 50 and the second radial dynamic pressure generating groove 52 are both cut by the cutting apparatus 200, and have the wavy undulations at the bottom surface of the groove.

A surface in which at least one of the first radial dynamic pressure generating groove 50, the second radial dynamic pressure generating groove 52, the first thrust dynamic pressure generating groove 54, the second thrust dynamic pressure generating groove 56, the first air flow generating groove 58, and the second air flow generating groove 59 is to be formed may include a surface layer formed by electroless nickel plating, identical to the electroless nickel plating performed on the hub 28 described above, for example. In this case, it is possible to suppress peeling of micro residue adhered on the processed surface.

As described above, in the disk drive unit 100 of this embodiment, the hub 28 and the sleeve 106 are integrally formed by magnetic stainless steel, for example, and the dynamic pressure generating groove and the air flow generating groove are formed in the hub 28 by the cutting apparatus 200. The dimension accuracy of the hub 28 and the sleeve 106 can be improved because the hub 28 and the sleeve 106 are integrally formed. In addition, by forming the dynamic pressure generating groove and the air flow generating groove with a high accuracy by the cutting process, the magnetic recording disk 8 can be held and rotated at a high speed in a stable manner. Further, the rigidity of the disk drive unit 100 can be improved.

According to the described embodiment and examples, it is possible to form a dynamic pressure generating groove of a fluid dynamic bearing with a high accuracy and improve rigidity of the disk drive unit.

Although the embodiment and examples of the present invention have been described in detail, it should be understood that the various changes, substitutions, and alterations could be made hereto without departing from the spirit and scope of the invention.

What is claimed is:

1. A method of manufacturing a disk drive unit that includes a rotor configured to rotate a disk set thereon, and a fixed body configured to rotatably support the rotor via a lubricant, the method comprising:
first cutting the rotor which integrally includes a sleeve part surrounding a shaft part of the fixed body and a hub part on which the disk is set, by a wavy cutting process to form a dynamic pressure generating groove configured to generate a dynamic pressure in the lubricant and having wavy undulations at a bottom part thereof;
second cutting a surface of the rotor opposing a ring-shaped member that is included in the fixed body and covers a gas-liquid interface of the lubricant provided between the rotor and the fixed body, by a wavy cutting process to form a first air flow generating groove configured to generate an air flow between the rotor and the ring-shaped member and having wavy undulations at a bottom part thereof; and
third cutting a surface of the hub part opposing the fixed body, by a wavy cutting process to form a second air flow generating groove configured to generate an air flow between the rotor and the fixed body and having wavy undulations at a bottom part thereof.

2. The method of manufacturing the disk drive unit as claimed in claim 1, wherein the first cutting forms a circumferential direction striated projecting part having a repetition pitch of 5 μm to 30 μm in a radial direction of the disk at the bottom part of the dynamic pressure generating groove.

3. The method of manufacturing the disk drive unit as claimed in claim 1, further comprising:
plating a surface in which the dynamic pressure generating groove is to be formed by a material identical to that plated on the hub part.

4. The method of manufacturing the disk drive unit as claimed in claim 1, wherein the sleeve part and the hub part are formed by an alloy that is magnetic or soft magnetic.

5. The method of manufacturing the disk drive unit as claimed in claim 1, wherein the sleeve part and the hub part are formed by a soft magnetic stainless steel.

6. The method of manufacturing the disk drive unit as claimed in claim 1, wherein the dynamic pressure generating groove has a herringbone shape or a spiral shape.

7. A method of manufacturing a disk drive unit that includes a rotor configured to rotate a disk set thereon, and a fixed body configured to rotatably support the rotor via a lubricant, the method comprising:
first cutting the rotor which integrally includes a sleeve part surrounding a shaft part of the fixed body and a hub part on which the disk is set, by a wavy cutting process to form a dynamic pressure generating groove configured to generate a dynamic pressure in the lubricant and having wavy undulations at a bottom part thereof; and
second cutting a surface of the rotor opposing a ring-shaped member that is included in the fixed body and covers a gas-liquid interface of the lubricant provided between the rotor and the fixed body, by a wavy cutting process to form a first air flow generating groove configured to generate an air flow between the rotor and the ring-shaped member and having wavy undulations at a bottom part thereof,
wherein a surface in which the dynamic pressure generating groove is to be formed includes a plated layer plated by a material identical to that plated on the hub part.

8. The method of manufacturing the disk drive unit as claimed in claim 7, further comprising:
third cutting a surface of the hub part opposing the fixed body, by a wavy cutting process to form a second air flow generating groove configured to generate an air flow between the rotor and the fixed body and having wavy undulations at a bottom part thereof.

9. The method of manufacturing the disk drive unit as claimed in claim 7, wherein the first cutting forms a circumferential direction striated projecting part having a repetition pitch of 5 μm to 30 μm in a radial direction of the disk at the bottom part of the dynamic pressure generating groove.

10. The method of manufacturing the disk drive unit as claimed in claim 7, further comprising:
plating the surface in which the dynamic pressure generating groove is to be formed by the material identical to that plated on the hub part in order to form the plated layer.

11. The method of manufacturing the disk drive unit as claimed in claim 7, wherein the sleeve part and the hub part are formed by an alloy that is magnetic or soft magnetic.

12. The method of manufacturing the disk drive unit as claimed in claim 7, wherein the sleeve part and the hub part are formed by a soft magnetic stainless steel.

13. The method of manufacturing the disk drive unit as claimed in claim 7, wherein the dynamic pressure generating groove has a herringbone shape or a spiral shape.

14. A method of manufacturing a disk drive unit that includes a rotor configured to rotate a disk set thereon, and a fixed body configured to rotatably support the rotor via a lubricant, the method comprising:
cutting the rotor which integrally includes a sleeve part surrounding a shaft part of the fixed body and a hub part on which the disk is set, by a wavy cutting process to form a dynamic pressure generating groove configured to generate a dynamic pressure in the lubricant and having wavy undulations at a bottom part thereof;
wherein the cutting forms a circumferential direction striated projecting part having a repetition pitch of 5 μm to 30 μm in a radial direction of the disk at the bottom part of the dynamic pressure generating groove.

15. The method of manufacturing the disk drive unit as claimed in claim 14, further comprising:
cutting a surface of the rotor opposing a ring-shaped member that is included in the fixed body and covers a gas-liquid interface of the lubricant provided between the rotor and the fixed body, by a wavy cutting process to form an air flow generating groove configured to generate an air flow between the rotor and the ring-shaped member and having wavy undulations at a bottom part thereof.

16. The method of manufacturing the disk drive unit as claimed in claim 14, further comprising:
cutting a surface of the hub part opposing the fixed body, by a wavy cutting process to form an air flow generating groove configured to generate an air flow between the rotor and the fixed body and having wavy undulations at a bottom part thereof.

17. The method of manufacturing the disk drive unit as claimed in claim 14, further comprising:
plating a surface in which the dynamic pressure generating groove is to be formed by the material identical to that plated on the hub part.

18. The method of manufacturing the disk drive unit as claimed in claim 14, wherein the sleeve part and the hub part are formed by an alloy that is magnetic or soft magnetic.

19. The method of manufacturing the disk drive unit as claimed in claim 14, wherein the sleeve part and the hub part are formed by a soft magnetic stainless steel.

20. The method of manufacturing the disk drive unit as claimed in claim 14, wherein the dynamic pressure generating groove has a herringbone shape or a spiral shape.
